(19) United States
(12) Patent Application Publication
(10) Pub. No.: US 2003/0131947 A1
(43) Pub. Date: Jul. 17, 2003

(54) Assembly for actuation of lateral bead-breaking arm for tyre changing machines

(75) Inventor: Franco Magnani, Correggio (IT)

Correspondence Address: THE FIRM OF KARL F ROSS, 5676 RIVERDALE AVENUE, PO BOX 900, RIVERDALE (BRONX), NY, 10471-0900, US

(73) Assignee: SICAM S.R.L.

(21) Appl. No.: 10/323,363

(22) Filed: Dec. 19, 2002

(30) Foreign Application Priority Data
Jan. 17, 2002 (IT) MO2002A000009

(51) Int. Cl. B60C 25/13

(52) U.S. Cl. 157/1.26

(57) ABSTRACT

The simplified assembly (1) for actuation of the lateral bead-breaking arm (2) for tyre changing machines (3), consisting of a box-like base frame (4) on at least one side (23) of which is articulated said arm (2) equipped with bead-breaking tool (5) and on which is supported a horizontal rotary platform (6) for supporting and clamping wheels (R), which box-like base frame (4) is also equipped with an upwardly projecting work tool supporting column (7), comprises at least one motor/gear motor (8) mounted in said box-like base frame (4) from which there projects a rotary motor-driven shaft (9) supporting a crank means (10) and an articulated connecting rod means (11) interposed between said crank means (10) and said lateral bead-breaking arm (2), which latter being alternately moveable between a release position and a pressing position on a tyre and vice versa.

### DESCRIPTION

The present invention relates to a simplified assembly for actuation of the lateral bead-breaking arm for tyre changing machines.

Tyre changing machines are provided on one side of the base frame with an arm equipped at one end with a substantially vertical tool for breaking the bead of tyres before they are demounted; said arm is hinged in a vertical axis to the opposite end in such a way that it can be swung horizontally between an open position in which it is distanced from the aforesaid base frame so as to permit the insertion of the tyre from the rim of which the tyre bead is to be broken, to a progressively closed position in which the bead-breaking tool presses on the bead of the tyre, thus detaching it from the edges of the rim.

The bead-breaking operation is performed in a number of steps, each time acting on an arc of the tyre by pressing it and releasing it until the entire circumference of the tyre has been completed, after which the tyre is turned around and the operation is repeated on the opposite side.

In conventional tyre changing machines, the aforesaid arm is actuated using a pneumatic cylinder acting on a rod which connects the arm transversally to the cylinder and transmits its alternating movement to it.

This cylinder is in turn controlled by a pedal positioned on the base of the machine and operated by the operator when required; said pedal is connected via a circuit to a valve that opens and closes the supply of compressed air which activates the actuator and hence the arm.

Although offering satisfactory performance, this method of actuating the bead-breaking arm is complex to construct and accounts for a significant portion on the overall cost of the tyre changing machine given that it consists of a multiplicity of components connected together by means of circuits and driven by valves and cylinders.

The main purpose of the present invention is to conceive a simplified assembly for the actuation of the lateral bead-breaking arm for tyre changing machines, in other words which is able to simplify significantly the structure that moves said bead-breaking arm in conventional tyre changing machines, thus reducing the componentry and ultimately the cost of said tyre changing machines.

This purpose and these aims are all achieved by the present simplified assembly as described in claim 1.

Further characteristics and advantages of the present invention will be more evident from the detailed description of a preferred, but not exclusive, embodiment of a simplified assembly for actuation of the lateral bead-breaking arm for tyre changing machines, which is illustrated by way of a non-limiting example in the enclosed drawings, in which:

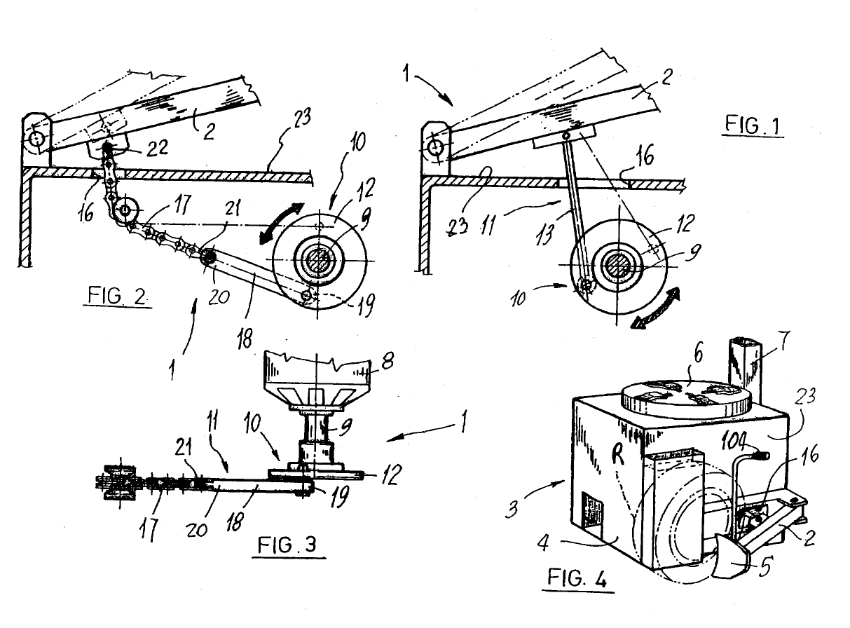

FIG. 1 is a schematic plan view of a first embodiment of a simplified assembly for actuation of the lateral bead-breaking arm for tyre changing machines according to the present invention;

FIG. 2 is a schematic plan view of a second embodiment of a simplified assembly for actuation of the lateral bead-breaking arm for tyre changing machines according to the present invention;

FIG. 3 is a side view of a simplified assembly for actuation of the lateral bead-breaking arm for tyre changing machines, in the embodiment of FIG. 2;

FIG. 4 is an assembly view, in reduced scale, of a tyre changing machine equipped with the simplified assembly according to the present invention;

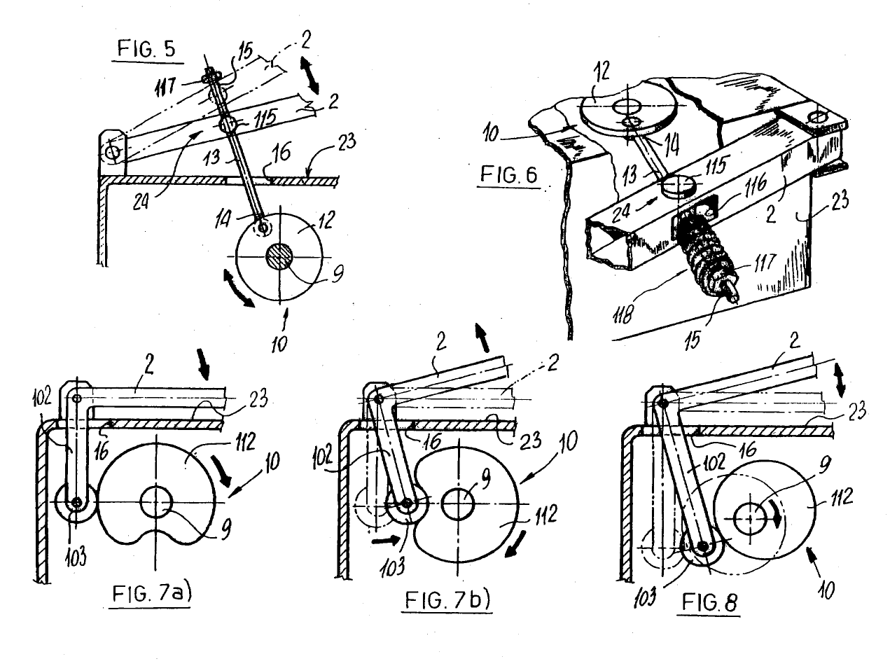

FIG. 5 is a schematic plan view of a third embodiment of a simplified assembly for actuation of the lateral bead-breaking arm for tyre changing machines;

FIG. 6 is a partial perspective view of the third embodiment of FIG. 5;

FIGS. 7a and 7b show a fourth embodiment of a simplified assembly for actuation of the lateral bead-breaking arm for tyre changing machines in two stages of movement;

FIG. 8 shows a fifth possible embodiment of a simplified assembly for actuation of the lateral bead-breaking arm for tyre changing machines.

With particular reference to these figures, the number 1 refers overall to a simplified assembly for actuation of the lateral bead-breaking arm 2 for tyre changing machines 3, consisting of a box-like base frame 4 on at least one side of which is articulated the arm 2, which is provided at its free end with a bead-breaking tool 5.

On the base frame 4 there is supported a horizontal rotary platform 6 for supporting and clamping the wheels, to which is engaged an upwardly projecting work tool supporting column, indicated schematically in the drawings as 7.

The simplified assembly 1 comprises at least one motor/gear motor 8 mounted inside the box-like base frame 4; from said motor/gear motor there extends a rotary motor-driven shaft 9, which supports a crank means 10.

A connecting rod means 11 is interposed between aforesaid crank means 10 and arm 2.

The crank means 10 comprises at least one disc 12 which is engaged with the free lower end of the rotary motor-driven shaft 9 and which is rotatingly integral therewith; the connection rod means 11 is eccentrically articulated to aforesaid disc 12.

In a first possible embodiment, said connecting rod means 11 consists of a preferably monolithic rod-shaped element 13, which has one articulated end 14 and the opposite end 15 free to slide inside a transversally perforated peg 115, which in turn passes orthogonally through arm 2; at the position of the through hole in peg 115, arm 2 is provided with a window 116 capable of permitting the free passage of the opposite end 15 of the rod-shaped element 13 on which end is mounted an enlargement, in this case a nut 117 with a stop function for preventing escape from the hole of peg 115.

Between the nut 117 and the peg 115 there is also inserted a shock-absorbing element, indicated overall as 118, to protect the rims: said element 118 may consist of a compression-loadable helical spring wound onto the rod-shaped element 13 or of a preferably cylindrical pad, threaded onto said rod-shaped element 13 and made of elastically deformable material.

In order to articulate with aforesaid crank means 10, the rod-shaped element 13 passes through a specific slot 16 made in the side of the base frame 4.

In a possible alternative embodiment, the connecting rod means 11 consists of a chain segment 17, flexible in a substantially horizontal plane and having one end connected to a small rigid bar 18, the head 19 of which is eccentrically articulated to the disc 12 and the opposite end 20 articulated to the head 21 of the chain segment 17, the opposite end 22 of which is articulated directly to the bead-breaking arm 2 by means of peg 115.

In a further possible embodiment of the invention, illustrated in FIGS. 7a and 7b, as well as FIG. 8, the end of the arm 2, articulated to the side 23 of the base frame 4, extends inside the latter, through the slot 16, with a section bent substantially at a right angle, indicated by 102, and bearing at its tip a low-friction contact element, in practice an idle wheel 103, capable of resting on the external edge of the crank means 10, in this case advantageously shaped as a discoid 112 with an eccentric perimeter profile.

The operation of the invention is intuitive and in general is as follows in all possible embodiments: when an operator has to break the bead of a tyre from its rim subsequent to deflation, he places the wheel “R” vertically against the side 23 of the box-like base frame 4, using the handle 104 to hold the arm 2 in a position distanced from the side 23 thereof.

The operator positions the wheel “R” in such a way that the active edge of the bead-breaking tool 5 is aligned with the side of the tyre and starts the motor/gear motor 8 which causes to turn by one revolution the head 19 of the rigid bar 18 or that of the rod-shaped element 13, both of which are eccentrically articulated to the disk 12.

For the first half of its movement, this revolution generates a tractive action on the arm 2, the intensity of which is controlled by the contrast action of the shock-absorbing element 118 interposed between the peg 115 and the nut 117; the arm 2, after overcoming the contrast force of element 118, is first attracted towards the side 23, thus compressing the bead and separating it from the edge of the rim on which it is mounted; during the second half of this revolution, the tractive action ceases and the arm 2 is released so as to be able to move away from said rim, thus freeing the wheel “R” and allowing the operator to reposition it with a second bead section to be broken in a position aligned with the bead-breaking tool 5 and thus repeat the operation first on one side of the tyre and then, after turning the wheel “R” around, on the other side of the tyre until the beads are completely detached from the edges of the rim.

When the arm 2 is not used and the gear motor 8 has the sole effect of rotating the platform 6, said arm 2 is kept resting against the side 23 of the base frame 4; this way the rod-shaped element 13, which continues to be driven by the alternating movement, is able to slide freely inside the hole made in the peg 115 and to project through the window 116 without producing any actions on the arm 2.

In the same rest condition of the arm 2 maintained against the side 23, in the embodiment of the invention that involves the use of the chain segment 17 as a substitute for the rigid rod-shaped element 13, it is the flexibility between the links of the chain segment that are able to “absorb” the alternating movement generated by the actuation of the gear motor 8 while it rotates the platform 6, without causing tractive actions on the arm 2, which therefore remains stationary.

In the further embodiment characterised by the angled shape of arm 2, the rotation of the crank means 10 determines the two open and closed positions thereof, following the movement of the external profile of the crank means 10, positioned by the operator who exercises a tractive action on arm 2 by means of the handle 104 to open it and insert a wheel “R”: the rotation of the crank means 10, by acting on the section 102, brings the arm 2 back towards the side 23 of the base frame 4 thereby performing the bead breaking operation with the bead-breaking tool 5.

If, in contrast, the arm 2 is maintained in contact with the side 23, the crank means 10 rotates without acting on the section 102, leaving the arm itself stationary: the gear motor unit 8 turns only the platform 6.

It has been observed in practice that the simplified assembly for actuation of the lateral bead-breaking arm for tyre changing machines according to the present invention fulfils the established aims.

The invention described is open to numerous modifications and variants, all of which fall within the scope of protection of the following claims.

Furthermore, all details are replaceable with others that are technically equivalent and any materials, forms and dimensions may be used according to requirements.

1) Simplified assembly (1) for actuation of the lateral bead-breaking arm (2) for tyre changing machines (3) consisting of a box-like base frame (4) on at least one side (23) of which is articulated said arm (2) equipped with bead-breaking tool (5) and on which is supported a horizontal rotary platform (6) for supporting and clamping wheels (R), which box-like base frame (4) is also equipped with an upwardly projecting work tool supporting column (7), characterised by the fact that it comprises at least one motor/gear motor (8) mounted inside said box-like base frame (4) from which there projects a rotary motor-driven shaft (9) supporting a crank means (10) and an articulated connecting rod means (11) interposed between said crank means (10) and said lateral bead-breaking arm (2), which latter being alternately moveable between a release position and a pressing position on a tyre and vice versa.

2) Simplified assembly (1) as defined in claim 1 characterised by the fact that said crank means (10) consists of at least one disc (12) engaged with the free end of said rotary motor-driven shaft (9) and eccentrically mutually articulated with said connecting rod means (11).

3) Simplified assembly (1) as defined in claim 1 characterised by the fact that said connecting rod means (11) consists of a rod-shaped element (13) with one end (14) articulated to said crank means (10) and the opposite end (15) articulated to said bead-breaking arm (2) with the interposition of guided sliding means (24).

4) Simplified assembly (1) as defined in claim 3 characterised by the fact that said sliding means (24) consist of at least one vertical through peg (115), inserted orthogonally into said arm (2) and transversally traversed by a hole in which said rod-shaped element (13) is slidingly inserted.

5) Simplified assembly (1) as defined in claims 3 and 4 characterised by the fact that said rod-shaped element (13) is provided at said opposite end (15) with an enlarged body (117) with a retaining stop function for said transversal hole of said vertical peg (115).

6) Simplified assembly (1) as defined in claim 5 characterised by the fact that a shock-absorbing means 118 can be inserted between said peg (115) and said enlarged body (117).

7) Simplified assembly (1) as defined in claim 6 characterised by the fact that said shock-absorbing means (118) is chosen out of at least one compression-loadable spring disposed on said rod-shaped element (13) and at least one pad made of elastically deformable material disposed on said rod-shaped element (13).

8) Simplified assembly (1) as defined in claim 3 characterised by the fact that said rod-shaped element (13) consists of a chain segment (17), flexible in a substantially horizontal plane and with one end (21) connected to a small rigid bar (18), the head (19) of which is eccentrically articulated to said crank means (10) and the opposite end (20) is articulated to the head (21) of said chain segment (17), the opposite end (22) of which is in turn articulated to said bead-breaking arm (2).

9) Simplified assembly (1) as defined in claim 1 characterised by the fact that said motor/gear motor (8) is anchored to the upper wall of said box-like base frame (4) and that said rotary motor-driven shaft (9) projects vertically downwards.

10) Simplified assembly (1) as defined in claim 1 characterised by the fact that said crank means (10) comprises at least one discoid element (112) engaged with the free end of said rotary motor-driven shaft (9) and externally shaped with an eccentric profile engageable with said connecting rod means (11).

11) Simplified assembly (1) as defined in claims 1 and 10 characterised by the fact that said connecting rod means (11) consists of an extension (102) of the end of said arm (2) articulated to and projecting inside said base frame (4), at the tip of which extension (102) there is mounted a means for low-friction contact with said eccentric profile of said discoid element (112).

12) Simplified assembly (1) as defined in claim 11 characterised by the fact that said low-friction contact means consists of at least one idle wheel (103) at the tip of said extension (102).
